(19) United States
(12) Patent Application Publication
(10) Pub. No.: US 2019/0080245 A1
(43) Pub. Date: Mar. 14, 2019

(54) Methods and Systems for Generation of a Knowledge Graph of an Object

(71) Applicant: Niantic, Inc., San Francisco, CA (US)

(72) Inventors: Ryan Michael Hickman, Sunnyvale, CA (US); Soohyun Bae, Los Gatos, CA (US)

(21) Appl. No.: 15/699,449

(22) Filed: Sep. 8, 2017

(51) Int. Cl. G06N 5/02; G06F 17/30; G06K 9/00; G06K 9/62; G10L 15/30

(52) U.S. Cl. CPC G06N 5/022; G06F 17/30864; G10L 15/30; G06K 9/6296; G06K 9/00664

(57) ABSTRACT

An example method includes obtaining, using a camera of a computing device, a two-dimensional (2D) image of an object, and receiving, from a server, an identification of the object based on the 2D image of the object. The method further includes obtaining, using one or more sensors of the computing device, additional data of the object, and obtaining, using the one or more sensors of the computing device, additional data of a surrounding environment of the object. Following, the method includes generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

### FIELD

The present disclosure relates generally to methods of collection of data of an environment and/or of objects in the environment, and more particularly, to generating a knowledge graph of an environment or an object including data organized in a hierarchical semantic manner to illustrate relationships between the object and the environment.

### BACKGROUND

With increased usage of computing networks, such as the Internet, people have access to an overwhelming amount of information from various structured and unstructured sources. However, information gaps are present as users may try to piece together what they can find that they believe to be relevant during searches for information on various subjects. Generally, searching on the Internet using a search engine results in many hits, and often times, a specific item of interest cannot be found.

Search engines sometimes reference knowledge graphs to provide search results with semantic search information, and the information can be gathered from a wide variety of sources. A knowledge graph includes data organized in a meaningful way to show connections between the data. Effectiveness of the knowledge graph is based on an amount of information contained in the graph as well as an amount of detail among the links between the data.

As mentioned, knowledge graphs are generated by gathering information from a. wide variety of sources. Typically, a knowledge graph is generated by performed web crawling of the Internet or other networks to obtain as much information as possible about a topic or object of interest. However, even still, much information can be missing in the knowledge graph such that a complete data set of the topic or object of interest cannot be found. Improvements are therefore desired.

### SUMMARY

In one example, a computer-implemented method is described. The computer-implemented method comprises obtaining, using a camera of a computing device, a two-dimensional (2D) image of an object, receiving, from a server, an identification of the object based on the 2D image of the object, obtaining, using one or more sensors of the computing device, additional data of the object, obtaining, using the one or more sensors of the computing device, additional data of a surrounding environment of the object, and generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

In another example, a computing device is described. The computing device comprises a camera, one or more sensors, at least one processor, memory, and program instructions, stored in the memory, that upon execution by the at least one processor cause the computing device to perform operations. The operations comprise obtaining, using the camera, a two-dimensional (2D) image of an object, receiving, from a server, an identification of the object based on the 2D image of the object, obtaining, using the one or more sensors, additional data of the object, obtaining, using the one or more sensors, additional data of a surrounding environment of the object, and generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

In still another example, a non-transitory computer-readable medium is described having stored therein instructions, that when executed by a computing device, cause the computing device to perform functions. The functions comprise obtaining, using a camera of the computing device, a two-dimensional (2D) image of an object, receiving, from a server, an identification of the object based on the 2D image of the object, obtaining, using one or more sensors of the computing device, additional data of the object, obtaining, using the one or more sensors of the computing device, additional data of a surrounding environment of the object, and generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

The features, functions, and advantages that have been discussed can be achieved independently in various examples or may be combined in yet other examples further details of which can be seen with reference to the following description and figures.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying figures, wherein:

FIG. 1 illustrates an example system, according to an example embodiment.

FIG. 2 illustrates an example of the computing device, according to an example embodiment.

FIG. 3 illustrates an example of a robotic device, according to an example embodiment.

FIG. 4 shows a flowchart of an example method, according to an example implementation.

FIG. 5 is a conceptual illustration of an example knowledge graph, according to an example implementation.

FIG. 6 shows a flowchart of an example method for use with the method of FIG. 4, according to an example implementation.

FIG. 7 shows another flowchart of an example method for use with the method of FIG. 4, according to an example implementation.

FIG. 8 shows another flowchart of an example method for use with the method of FIG. 4, according to an example implementation.

FIG. 9 shows another flowchart of an example method for use with the method of FIG. 4, according to an example implementation.

FIG. 10 shows another flowchart of an example method for use with the method of FIG. 4, according to an example implementation.

FIG. 11 shows another flowchart of an example method for use with the method of FIG. 4, according to an example implementation.

FIG. 12 shows another flowchart of an example method for use with the method of FIG. 4, according to an example implementation.

FIG. 13 is a conceptual illustration of an example two-dimensional (2D) image of an object, according to an example implementation.

FIG. 14 is a conceptual illustration of example additional data of the object, according to an example implementation.

FIG. 15 is a conceptual illustration of another example additional data of the object, according to an example implementation.

FIG. 16 is a conceptual illustration of another example additional data of the object, according to an example implementation.

FIG. 17 is a conceptual illustration of another example additional data of the object, according to an example implementation.

FIG. 18 is a conceptual illustration of another example additional data of the object, according to an example implementation.

FIG. 19 is a conceptual illustration of another example additional data of the object, according to an example implementation.

### DETAILED DESCRIPTION

Disclosed examples will now be described more fully hereinafter with reference to the accompanying figures, in which some, but not all of the disclosed examples are shown. Indeed, several different examples may be provided and should not be construed as limited to the examples set forth herein. Rather, these examples are provided so that this disclosure will be thorough and complete and will fully convey the scope of the disclosure to those skilled in the art.

Described herein are systems and methods for generating a knowledge graph and/or modifying an existing knowledge graph. Methods include obtaining, using a camera of a computing device, a two-dimensional (2D) image of an object, and receiving an identification of the object based on the 2D image of the object. The methods further include obtaining, using one or more sensors of the computing device, additional data of the object, and additional data of a surrounding environment of the object. Following, methods include generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

One example method involves obtaining additional data of the object such as images of the object from additional points of view. Another example method involves obtaining additional data of the object such as depth images of the object. Still another example involves obtaining additional data of the object such as, using the microphone, obtaining audio from the surrounding environment of the object.

In an example scenario, the computing device is or includes a robotic device operable to move throughout an environment, and the robotic device moves around the object to collect additional data of the object using one or more sensors on-board the robotic device.

Additional data of an object or of an environment of the object may include data of any kind such as images, audio, location data, contextual data, and semantic data. In some examples, a person can be associated with the object, and the additional data includes information indicating the person who is associated with the object to label the object as belonging to the person.

One example device includes a computing device having a camera, one or more sensors, at least one processor, memory, and program instructions, stored in the memory, that upon execution by the at least one processor cause the computing device to perform operations of obtaining, using the camera, a two-dimensional (2D) image of an object, and receiving an identification of the object based on the 2D image of the object. The device then obtains, using the one or more sensors, additional data of the object, and additional data of a surrounding environment of the object. The device may then generate a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

Advantageously, the systems and methods disclosed herein may facilitate generation of a knowledge graph, and enable collection of data in a variety of manners to collect a full data set of the object or the environment. Data collection may be performed autonomously by a robotic device, or manually by a user using a computing device.

Using the example systems and methods, new and existing datasets of objects and environments can be further semantically labeled to create or modify a knowledge graph and start a tree of knowledge, and as well as link new observations off of the existing graphs. New observations can include new types of information, namely, depth image data, audio data, activity data, contextual data, etc. Further, observations of contextual data that led up to detecting the object can be associated with the object in the graph.

Various other features of these systems and methods are described hereinafter with reference to the accompanying figures.

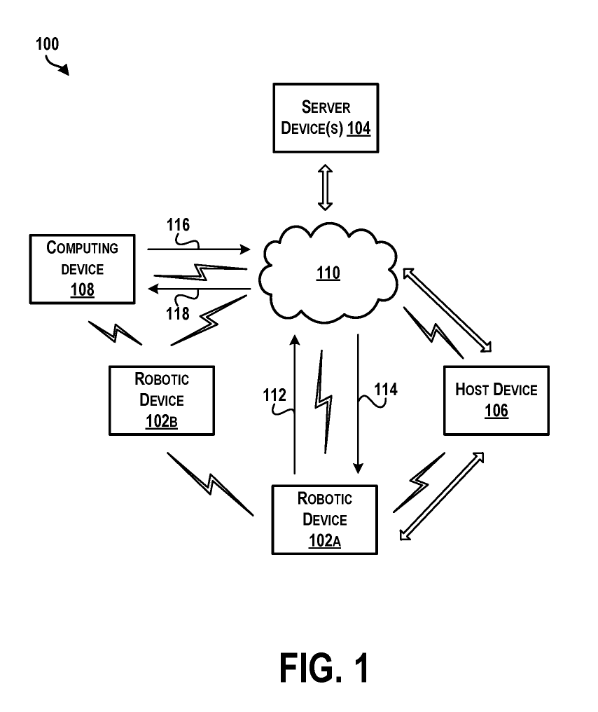

Referring now to FIG. 1, an example system 100 is illustrated. In particular, FIG. 1 illustrates an example system 100 for modifying or generating a knowledge graph of an object(s) and/or of an environment(s). As shown in FIG. 1, system 100 includes robotic devices 102a, 102b, at least one server device 104, a host device 106, a computing device 108, and a communications network 110.

Robotic devices 102a, 102b may be any type of device that has at least one sensor and is configured to record sensor data in accordance with the embodiments described herein. In some cases, the robotic devices 102a, 102b, may also include locomotion capability (e.g., drive systems) that facilitate moving within an environment.

As shown in FIG. 1, robotic device 102a may send data 112 to and/or receive data 114 from the server device 104 and/or host device 106 via communications network 110. For instance, robotic device 102a may send a log of sensor data to the server device 104 via communications network 110. Additionally or alternatively, robotic device 102a may receive machine learning model data from server device 104. Similarly, robotic device 102a may send a log of sensor data to host device 106 via communications network 110 and/or receive machine learning model data from host device 106. Further, in some cases, robotic device 102a may send data to and/or receive data directly from host device 106 as opposed to via communications network 110.

Server device 104 may be any type of computing device configured to carry out computing device operations described herein. For example, server device 104 can include a remote server device and may be referred to as a “cloud-based” device. In some examples, server device 104 may include a cloud-based server cluster in which computing tasks are distributed among multiple server devices. In line with the discussion above, server device 104 may be configured to send data 114 to and/or receive data 112 from robotic device 102a via communications network 110. Server device 104 can include a machine learning server device that is configured to train a machine learning model.

Like server device 104, host device 106 may be any type of computing device configured to carry out the computing device operations described herein. However, unlike server device 104, host device 106 may be located in the same environment (e.g., in the same building) as robotic device 102a. In one example, robotic device 102a may dock with host device 106 to recharge, download, and/or upload data.

Although robotic device 102a is capable of communicating with server device 104 via communications network 110 and communicating with host device 106, in some examples, robotic device 102a may carry out the computing device operations described herein. For instance, robotic device 102a may include an internal computing system and memory arranged to carry out the computing device operations described herein.

In some examples, robotic device 102a may wirelessly communicate with robotic device 102b via a wireless interface. For instance, robotic device 102a and robotic device 102b may both operate in the same environment, and share data regarding the environment from time to time.

The computing device 108 may perform all functions as described with respect to the robotic devices 102a, 102b except that the computing device 108 may lack locomotion capability (e.g., drive systems) to autonomously move within an environment. The computing device 108 may take the form of a desktop computer, a laptop computer, a mobile phone, a PDA, a tablet device, a smart watch, wearable computing device, handheld camera computing device, or any type of mobile computing device, for example. The computing device 108 may also send data 116 to and/or receive data 118 from the server device 104 via communications network 110.

The communications network 110 may correspond to a local area network (LAN) a wide area network (WAN), a corporate intranet, the public internet, or any other type of network configured to provide a communications path between devices. The communications network 110 may also correspond to a combination of one or more LANs, WANs, corporate intranets, and/or the public Internet. Communications among and between the communications network 110 and the robotic device 102a, the robotic device 102b, and the computing device 108 may be wireless communications (e.g., WiFi, Bluetooth, etc.).

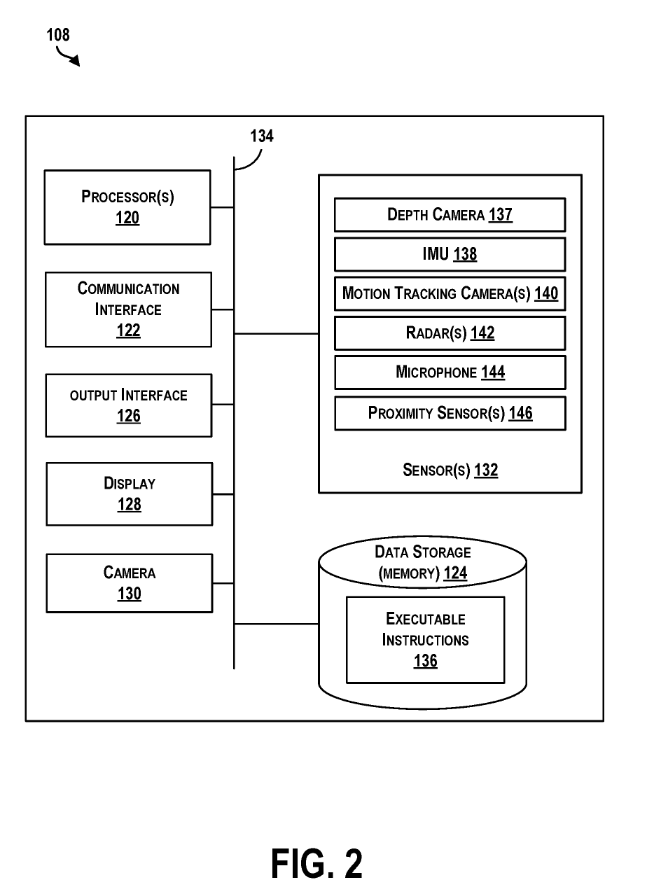

FIG. 2 illustrates an example of the computing device 108, according to an example embodiment. FIG. 2 shows some of the components that could be included in the computing device 108 arranged to operate in accordance with the embodiments described herein. The computing device 108 may be used to perform functions of methods as described herein.

The computing device 108 is shown to include a processor(s) 120, and also a communication interface 122, data storage (memory) 124, an output interface 126, a display 128, a camera 130, and sensors 132 each connected to a communication bus 134. The computing device 108 may also include hardware to enable communication within the computing device 108 and between the computing device 108 and other devices (not shown). The hardware may include transmitters, receivers, and antennas, for example.

The communication interface 122 may be a wireless interface and/or one or more wireline interfaces that allow for both short-range communication and long-range communication to one or more networks or to one or more remote devices. Such wireless interfaces may provide for communication under one or more wireless communication protocols, such as Bluetooth, WiFi (e.g., an institute of electrical and electronic engineers (IEEE) 802.11 protocol), Long-Term Evolution (LTE), cellular communications, near-field communication (NFC), and/or other wireless communication protocols. Such wireline interfaces may include Ethernet interface, a Universal Serial Bus (USB) interface, or similar interface to communicate via a wire, a twisted pair of wires, a coaxial cable, an optical link, a fiber-optic link, or other physical connection to a wireline network. Thus, the communication interface 122 may be configured to receive input data from one or more devices, and may also be configured to send output data to other devices.

The communication interface 122 may also include a user-input device, such as a keyboard, mouse, or touchscreen, for example.

The data storage 124 may include or take the form of one or more computer-readable storage media that can be read or accessed by the processor(s) 120. The computer-readable storage media can include volatile and/or non-volatile storage components, such as optical, magnetic, organic or other memory or disc storage, which can be integrated in whole or in part with the processor(s) 120. The data storage 124 is considered non-transitory computer readable media. In some examples, the data storage 124 can be implemented using a single physical device (e.g., one optical, magnetic, organic or other memory or disc storage unit), while in other examples, the data storage 124 can be implemented using two or more physical devices.

The data storage 124 thus is a non-transitory computer readable storage medium, and executable instructions 136 are stored thereon. The instructions 136 include computer executable code. When the instructions 136 are executed by the processor(s) 120, the processor(s) 120 are caused to perform functions. Such functions include e.g., obtaining, using the camera 130, a two-dimensional (2D) image of an object, receiving, from the server 104, an identification of the object based on the 2D image of the object, obtaining, using the one or more sensors 132, additional data of the object, obtaining, using the one or more sensors 132, additional data of a surrounding environment of the object, and generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object. These functions are described in more detail below.

The processor(s) 120 may be a general-purpose processor or a special purpose processor (e.g., digital signal processors, application specific integrated circuits, etc.). The processor(s) 120 can include one or more CPUs, such as one or more general purpose processors and/or one or more dedicated processors (e.g., application specific integrated circuits (ASICs), digital signal processors (DSPs), network processors, etc.). For example, the processor(s) 170 can include a tensor processing unit (TPU) for training and/or inference of machine learning models. The processor(s) 120 may receive inputs from the communication interface 122, and process the inputs to generate outputs that are stored in the data storage 124 and output to the display 128. The processor(s) 120 can be configured to execute the executable instructions 136 (e.g., computer-readable program instructions) that are stored in the data storage 124 and are executable to provide the functionality of the computing device 108 described herein.

The output interface 126 outputs information to the display 128 or to other components as well. Thus, the output interface 126 may be similar to the communication interface 122 and can be a wireless interface (e.g., transmitter) or a wired interface as well.

The camera 130 may include a high-resolution camera to capture 2D images of objects and environment.

The sensors 132 include a number of sensors such as a depth camera 137, an inertial measurement unit (IMU) 138, one or more motion tracking cameras 140, one or more radars 142, one or more microphone arrays 144, and one or more proximity sensors 146. More or fewer sensors may be included as well.

Depth camera 137 may be configured to recover information regarding depth of objects in an environment, such as three-dimensional (3D) characteristics of the objects. For example, depth camera 137 may be or include an RGB-infrared (RGB-IR) camera that is configured to capture one or more images of a projected infrared pattern, and provide the images to a processor that uses various algorithms to triangulate and extract 3D data and outputs one or more RGBD images. The infrared pattern may be projected by a projector that is integrated with depth camera 137. Alternatively, the infrared pattern may be projected by a projector that is separate from depth camera 137 (not shown).

IMU 138 may be configured to determine a velocity and/or orientation of the robotic device. In one example, IMU may include a 3-axis gyroscope, a 3-axis accelerometer, a 3-axis compass, and one or more processors for processing motion information.

Motion tracking camera 140 may be configured to detect and track movement of objects by capturing and processing images (e.g., RGB-IR images). In some instances, the motion tracking camera 140 may include one or more IR light emitting diodes (LEDs) that enable detection in low-luminance lighting conditions. Motion tracking camera 140 may include a wide field of view (FOV), such as a 180 degree FOV. In one example configuration, the computing device 108 may include a first motion tracking camera configured to capture images on a first side of the computing device 108 and a second motion tracking camera configured to capture images on an opposite side of the computing device 108.

Radar 142 may include an object-detection system that uses electromagnetic waves to determine a range, angle, or velocity of objects in an environment. Radar 142 may operate by firing laser pulses out into an environment, and measuring reflected pulses with one or more sensors. In one example, radar 142 may include a solid-state millimeter wave radar having a wide FOV, such as a 150 degree FOV.

Microphone 144 may include a single microphone or a number of microphones (arranged as a microphone array) operating in tandem to perform one or more functions, such as recording audio data. In one example, the microphone 144 may be configured to locate sources of sounds using acoustic source localization.

Proximity sensor 146 may be configured to detect a presence of objects within a range of the computing device 108. For instance, proximity sensor 146 can include an infrared proximity sensor. In one example, the computing device 108 may include multiple proximity sensors, with each proximity sensor arranged to detect objects on different sides of the computing device 108 (e.g., front, back, left, right, etc.).

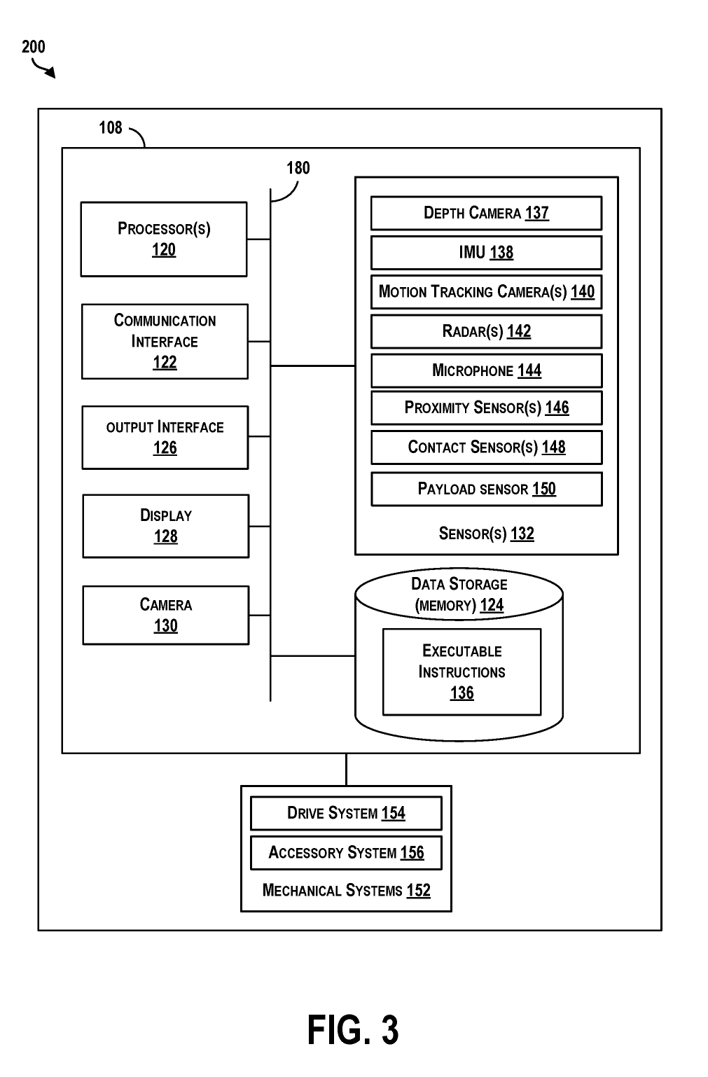

FIG. 3 illustrates an example of a robotic device 200, according to an example embodiment. FIG. 2 shows some of the components that could be included in the robotic device 200 arranged to operate in accordance with the embodiments described herein. The robotic device 200 may be used to perform functions of methods as described herein.

The robotic device 200 may include the same or similar components of the computing device 108 (and/or may include a computing device 108) including the processor(s) 120, the communication interface 122, the data storage (memory) 124, the output interface 126, the display 128, the camera 130, and the sensors 132 each connected to the communication bus 134. Description of these components is the same as above for the computing device 108. The robotic device 200 may also include hardware to enable communication within the robotic device 200 and between the robotic device 200 and other devices (not shown). The hardware may include transmitters, receivers, and antennas, for example.

The robotic device 200 may also include additional sensors 132, such as contact sensor(s) 148 and a payload sensor 150.

Contact sensor(s) 148 may be configured to provide a signal when robotic device 200 contacts an object. For instance, contact sensor(s) 148 may be a physical bump sensor on an exterior surface of robotic device 200 that provides a signal when contact sensor(s) 148 comes into contact with an object.

Payload sensor 150 may be configured to measure a weight of a payload carried by robotic device 200. For instance, payload sensor 150 can include a load cell that is configured to provide an electrical signal that is proportional to a force being applied to platform or other surface of robotic device 200.

As further shown in FIG. 3, the robotic device 200 also includes mechanical systems 152 coupled to the computing device 108, and the mechanical systems 152 include a drive system 154 and a accessory system 156. Drive system 154 may include one or more motors, wheels, and other components that can be controlled to cause robotic device 200 to move through an environment (e.g., move across a floor). In one example, drive system 154 may include an omnidirectional drive system that can be controlled to cause robotic device 200 to drive in any direction.

Accessory system 156 may include one or more mechanical components configured to facilitate performance of an accessory task. As one example, accessory system 156 may include a motor and a fan configured to facilitate vacuuming. For instance the electric motor may cause the fan to rotate in order to create suction and facilitate collecting dirt, dust, or other debris through an intake port. As another example, the accessary system 156 may include one or more actuators configured to vertically raise a platform or other structure of robotic device 200, such that any objects placed on top of the platform or structure are lifted off of the ground. In one example, accessory system 156 may be configured to lift a payload of about 10 kilograms. Other examples are also possible depending on the desired activities for the robotic device 200.

Within examples, the computing device 108 may be used by a user and/or the robotic devices 102a, 102b can be programmed to autonomously collect data and generate or modify a knowledge graph of objects or environments. Initially, known labeled data can be accessed, such as use of a cloud object recognizer to determine an identification of an object within a captured image. In an example scenario, the robotic device 102a may be driving around an environment and may capture 2D RGB images of objects using the camera 130 (e.g., an image of a dining room table), and the table can be identified using the cloud object recognizer with the 2D image as in the input. Now, once the table has been recognized, the robotic device 102a can also obtain more data about the table that is to be labeled and associated with the table in a knowledge graph of the table. As examples, additional images of other viewpoints, additional types of data (e.g., depth images, location in the dining room, etc.) can be gathered and stored with the knowledge graph of the table. In sum, additional observations of the table are collected from different points of view to generate or modify a knowledge graph of the table, that can then be used for training a new object classifier, for example.

When new data is collected by the robotic device 102a of the table, such as new observations from many vantage points and at various/different times of day, a large dataset is generated that describes the table, and also, describes items associated with the table (e.g., chairs and their positions with respect to the table). Thus, an initial object recognition can be performed using a single 2D image, and a knowledge graph can be expanded using data collected with respect to a context of the object.

As another example, a generic knowledge graph may specify an object is associated with a certain location (e.g., a plate is associated with a kitchen counter, which is associated with a kitchen, which is an example of a higher level space within a home). Examples herein can be performed to gather yet more detailed and contextual information to further annotate the knowledge graph and organize the data in a hierarchical semantic manner to illustrate relationships between the objects (e.g., labels from general to detail such as home-kitchen-counter-plate). Other examples can include gathering data to enable label objects personally (e.g., identify shoes, determine specific model, determine that shoes belong to John Smith, and disambiguating between other shoes owned and worn by John Smith).

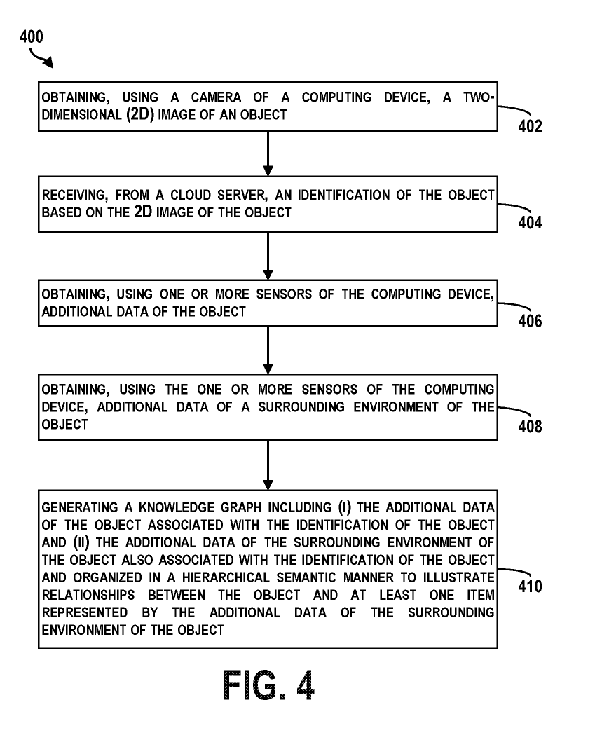

FIG. 4 shows a flowchart of an example method 400, according to an example implementation. Method 400 shown in FIG. 4 presents an embodiment of a method that, for example, could be carried out by a computing device or a robotic device, such as any of the computing devices or robotic devices depicted in any of the Figures herein. As such, the method 400 may be a computer-implemented method. It should be understood that for this and other processes and methods disclosed herein, flowcharts show functionality and operation of one possible implementation of present embodiments. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

Method 400 may include one or more operations, functions, or actions as illustrated by one or more of blocks 402-410. It should be understood that for this and other processes and methods disclosed herein, flowcharts show functionality and operation of one possible implementation of present examples. In this regard, each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. Further, the program code can be encoded on a computer-readable storage media in a machine-readable format, or on other non-transitory media or articles of manufacture. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block in FIG. 4, and within other processes and methods disclosed herein, may represent circuitry that is wired to perform the specific logical functions in the process. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 402, the method 400 includes obtaining, using the camera 130 of the computing device 108, a two-dimensional (2D) image of an object. For example, a user may use the computing device 108 to capture an image of an object, or the robotic device 102a may be programmed to capture a 2D image of an object using the camera 130.

At block 404, the method 400 includes receiving, from the server 104, an identification of the object based on the 2D image of the object. For example, the computing device 108 and/or the robotic device 102a may send the 2D image of the object to the server 104, which performs an object recognition using any type of cloud object recognizer, and then returns an identification of the object to computing device 108 and/or the robotic device 102a. The identification may indicate any number or type of information such as a name of the object (e.g., a chair), a category of the object, a model of the object, etc.

At block 406, the method 400 includes obtaining, using one or more sensors 132 of the computing device 108, additional data of the object. In one example, obtaining the additional data of the object includes obtaining images of the object from additional points of view, or of a different scale. In another example, obtaining the additional data of the object includes obtaining different types of data, such as depth images of the object.

In yet another example, obtaining the additional data of the object includes obtaining, using the microphone 144, audio from the surrounding environment of the object. In an example scenario, the 2D image may be of a table located in a kitchen in a house, and audio can be recorded in a vicinity of the table to document sounds that occur in the kitchen and that can be included in the knowledge graph of the table.

In another example scenario in which the method is performed by the robotic device 102a operable to move throughout an environment, obtaining the additional data of the object includes the robotic device 102a moving around the object to collect data of the object using the sensors 132 on-board the robotic device 102a. In this scenario, the robotic device 102a may capture additional images from all different points of view and poses of the object, and also may capture additional images of portions of the object too that can be associated with the object. As the robotic device 102a approaches the table, a field of view of the table to the robotic device 102a is reduced and once within a certain distance, the robotic device 102a may only have legs of the table in the field of view. Thus, images of the legs of the table can be captured and associated with the knowledge graph of the table as well to provide yet further detailed data useful for describing the table.

In yet further examples, obtaining the additional data of the object includes obtaining the additional data at different times of day. For example, lighting of the scene and environment in which the object is present changes throughout the day, and thus, images of the object can be captured over time during the day to gather data about the object as observed with various changes in lighting. The robotic device 102a can be programmed to return to a location of the object at different times of day, or at every hour of the day, to collect data of the object, for example.

At block 408, the method 400 includes obtaining, using the one or more sensors 132 of the computing device 108, additional data of a surrounding environment of the object. Thus, after obtaining additional data of the object, additional data of the surrounding environment can also be obtained so as to gather yet further details to be associated with the object in the knowledge graph to generate a full dataset to describe the object. Additional data of the environment may be collected in the same or similar manners as with respect to collecting additional data of the object. The surrounding environment may include a room in which the object is present, for example. The surrounding environment may computing device 108 and/or the robotic device 102a alternatively be more granular to only include a space around the object defined by boundaries of various distances (e.g., within 5-10 feet of the object). Still further, the surrounding environment may additionally or alternatively be defined to be more expansive and may include an entire house in which the object is present.

At block 410, the method 400 includes generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object. The knowledge graph can be generated by the computing device 108 and stored in memory of the computing device 108, or generated by the server 104 and stored in memory of the server 104, for example.

Within the knowledge graph, the additional data of the object is stored with a label indicating the identification of the object.

Within examples described herein, the knowledge graph can be generated by a computing device by generating a new knowledge graph, modifying an existing knowledge graph, generation of a knowledge graph based on guidance/seeding of a graph framework, or any combination of these. As an example, a framework of the knowledge graph can be curated by operators or obtained from other sources, and the computing device can use the framework in addition with machine learning or unsupervised learning to determine how and where to add additional nodes and details on the braches as leaves of the graph. Similarly, the framework can have associated object relationships such as physical adjacency (on top, under, next to, etc.) for certain objects or how objects may be used together. Any pre-defined attributes can be associated with the framework to further construct details of the knowledge graph with the additional data that is obtained using the computing device, for example.

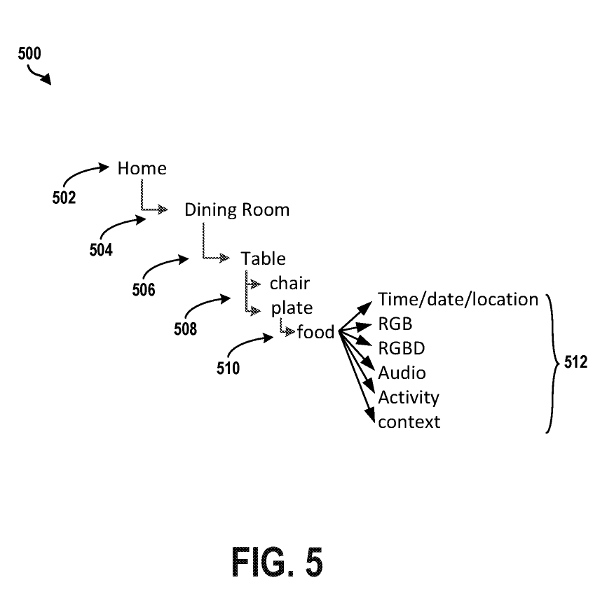

FIG. 5 is a conceptual illustration of an example knowledge graph 500, according to an example implementation. The knowledge graph 500 includes many hierarchical levels, and each level includes a branch linking the level to one that has more detailed information of the subject of the knowledge graph. In FIG. 5, a highest level 502 includes a node with an identification of “Home”, and a next level 504 is linked to the level 502 through a branch to indicate a specific area of the home, namely, a “Dining Room”. The Dining Room is thus associated with this specific Home. Continuing down the graph, a next level 506 indicates an object in the Dining Room, namely a Table. A next level 508 indicates items associated with the Table, namely, a chair and a plate. Following, a next level 510 indicates an item associated with the Plate, namely, food. Then, any number or type of data may be associated with the level 510, including data 512 indicating a time/date/location of the food, RGB images, RGBD images, audio of a surrounding environment, activity recognition associated with the object (food), contextual information associated with the object (food), etc.

The knowledge graph thus includes the additional data 512 of the object associated with the identification of the object (e.g., food) and additional data of the surrounding environment of the object also associated with the identification of the object. All information in the knowledge graph is organized in a hierarchical semantic manner starting with general/high level descriptions of a Home and continuing to more granular/detailed descriptions of areas and objects in the Home to illustrate relationships between the object and at least one item represented by the additional data of the surrounding environment of the object. All of the additional data 512 is collected by the computing device 108 and/or robotic device 200 using sensors 132 to enable a more complete dataset to be generated that describes the object.

Although not shown in the knowledge graph 500 of FIG. 5, the computing device 108 can be used to collect additional data for each node of the knowledge graph, such that the Dining Room, Table, Chair, etc., can all have additional data collected and associated therewith to more fully describe each object or portion of the environment.

A goal of the knowledge graph 500 is to describe, in as complete manner as possible and with as much data and different data types as possible, areas in an environment and also objects in the environment. By using the suite of sensors 132, all different types of data can be collected by the computing device 108 to enable a full description to be generated. Then, a knowledge graph can be generated, or an existing knowledge graph can be modified to generate further branches that are populated with the additional data that is collected.

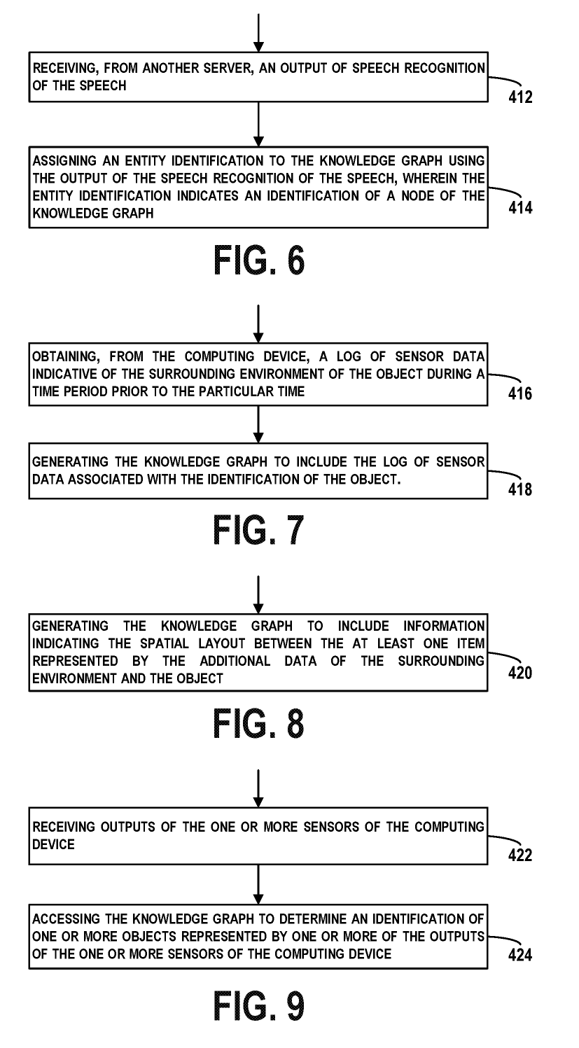

FIG. 6 shows a flowchart of an example method for use with the method 400, according to an example implementation. In some examples, the additional data of the object includes audio including speech, and at block 412, functions include receiving, from another server, an output of speech recognition of the speech, and at block 414, functions include assigning an entity identification to the knowledge graph using the output of the speech recognition of the speech. The entity identification indicates an identification of a node of the knowledge graph. For example, referring to FIG. 5, a user may use the computer device 108 to capture an image, and then the computing device 108, using the microphone 144, records speech of the user. The recording can include the user speaking a description of the image. An example scenario may include a user mapping out their home and speaking while using the computing device 108 to capture images. When user verbally speaks, the computing device 108 records the speech, and can determine that an image is referred to as a “Dining Room”, via an output of a cloud speech recognizer, and such images can be appropriately labeled. The label can also be associated with an entity ID in the knowledge graph 500, so as to label a node of the level 504 with dining room, for example.

FIG. 7 shows another flowchart of an example method for use with the method 400, according to an example implementation. Within an example, the 2D image of the object has a particular time associated with the 2D image, and at block 416, functions include obtaining, from the computing device, a log of sensor data indicative of the surrounding environment of the object during a time period prior to the particular time, and at block 418, functions include generating the knowledge graph to include the log of sensor data associated with the identification of the object. In an example, the computing device 108 and/or the robotic device 200 can be configured to collect sensor data at all times (e.g., always on microphone) or at programmed times. In any event, a log of sensor data may be collected and stored, and this previously collected data can be associated with a newly identified object in the knowledge graph 500. For instance, upon identifying “food”, and labeling the level 510 as food in the knowledge graph 500, it may be helpful to associate data with this level 510 that describes contextually the scene that led up to the food being positioned on the plate. Such information can include audio (e.g., noises of cooking), images of the food prior to cooking, activity recognition data of a person cooking, a time at which cooking was initiated and a time at which cooking was completed, etc. All of this data can then be hung off of a newly generated branch, e.g., data 512, on the knowledge graph 500 to more fully describe the object (food).

In an example scenario, including past collected data can be helpful for instances in which the knowledge graph 500 is used for object recognition. For instance, an image of a cooked egg differs from an image of an uncooked egg in a shell. Thus, having prior images of an uncooked egg associated with images/data of the cooked egg as positioned on the plate enables the computing device 108 to capture an image of the cooked egg and perform object recognition through use of the knowledge graph 500, and to enable improved artificial intelligence functions to be performed.

FIG. 8 shows another flowchart of an example method for use with the method 400, according to an example implementation. Within examples, the additional data of the surrounding environment indicates a spatial layout between the at least one item represented by the additional data of the surrounding environment and the object, and at block 420, functions include generating the knowledge graph to include information indicating the spatial layout between the at least one item represented by the additional data of the surrounding environment and the object. The spatial layout can include or indicate distances between the object and other objects in the environment, for example, a spacing between the chair and the table. Such information may be useful for a robotic device, in instances in which the robotic device is capable of rearranging items in the dining room, so as to reposition the chairs according to the data in the knowledge graph indicating the spatial layout, for example. The spatial layout provides a physical relationship between objects to enable the computing device 108 and/or the robotic device 200 to perform improved artificial intelligence functions due to a better understanding of common layouts of items. The spatial layout can also indicate a canonical layout of items in the home for determination of valid placements of objects, for example.

FIG. 9 shows another flowchart of an example method for use with the method 400, according to an example implementation. At block 422, functions include receiving outputs of the one or more sensors of the computing device, and at block 424, functions include accessing the knowledge graph to determine an identification of one or more objects represented by one or more of the outputs of the one or more sensors of the computing device. In this example scenario, the computing device 108 collects data and references the knowledge graph to perform an object recognition, for example, rather than using a cloud object recognizer. Over time, as the knowledge graph is further enhanced with the additional data, the knowledge graph can be used and referenced for object recognition, activity recognition, etc.

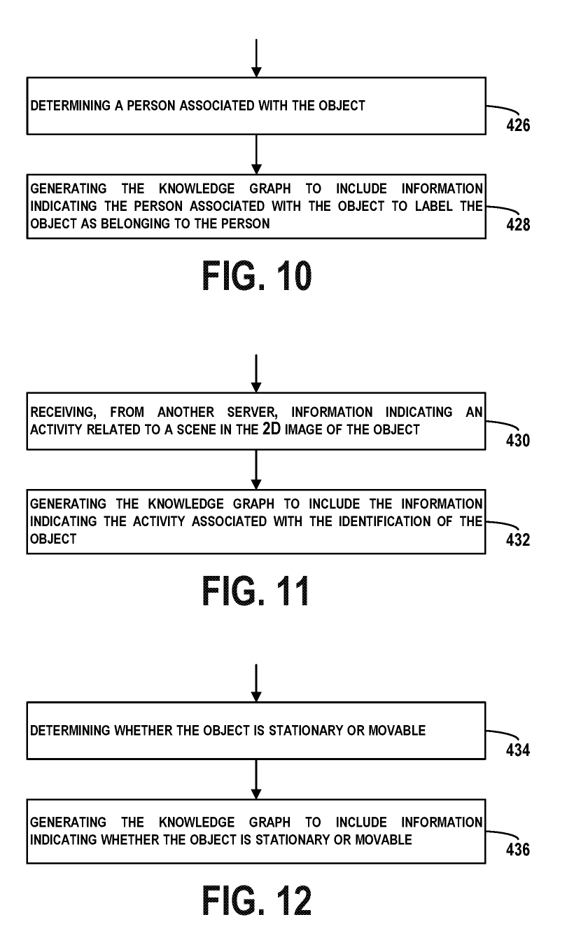

FIG. 10 shows another flowchart of an example method for use with the method 400, according to an example implementation. At block 426, functions include determining a person associated with the object, and at block 428, functions include generating the knowledge graph to include information indicating the person associated with the object to label the object as belonging to the person. For example, the computing device 108 may generate a prompt requesting information of a room, for example, to determine if the room is a bedroom, and if so, what person is associated with this bedroom. In other instances, the computing device 108 may generate a prompt to request information of shoes to determine who owns the shoes. This personal information can also be included into the knowledge graph 500, so as to provide yet further details of objects.

FIG. 11 shows another flowchart of an example method for use with the method 400, according to an example implementation. At block 430, functions include receiving, from another server, information indicating an activity related to a scene in the 2D image of the object, and at block 432, functions include generating the knowledge graph to include the information indicating the activity associated with the identification of the object. Activity can be determined by reference to a cloud activity recognition server. For example, the computing device 108 may send the 2D image to the cloud activity recognition server, which performs functions to determine an activity occurring in a scene of the image, and returns information indicating the identified activity to the computing device 108. Such information can be added to the knowledge graph 500, as shown in FIG. 5.

FIG. 12 shows another flowchart of an example method for use with the method 400, according to an example implementation. At block 434, functions include determining whether the object is stationary or movable, and at block 436, functions include generating the knowledge graph to include information indicating whether the object is stationary or movable. As an example, images of the object can be analyzed, using a cloud server, to determine if the object moves or not. Additionally or alternatively, once an identification of the object is determined, web searches can be performed to query whether such an object has a capability to autonomously move. Still further, the computing device 108 and/or the robotic device 200 may simply generate a prompt (e.g., audio or visual display) to query the user as to whether the identified object has a capability to autonomously move. Resulting information can be associated with the object in the knowledge graph (e.g., a plate is a static item).

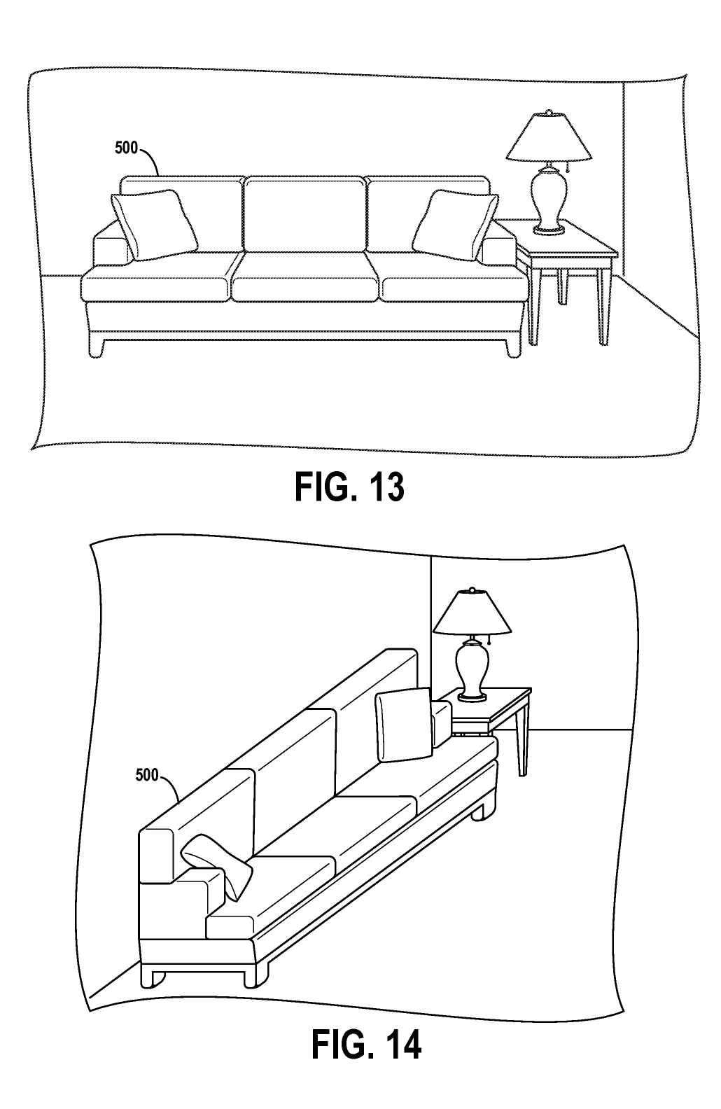

FIG. 13-19 are conceptual illustrations of additional data obtained of objects and of a surrounding environment of the objects, according to example implementations. FIG. 13 is a conceptual illustration of an example two-dimensional (2D) image of an object 500, for example, a couch. Following, additional data of the couch and the environment of the couch can be obtained.

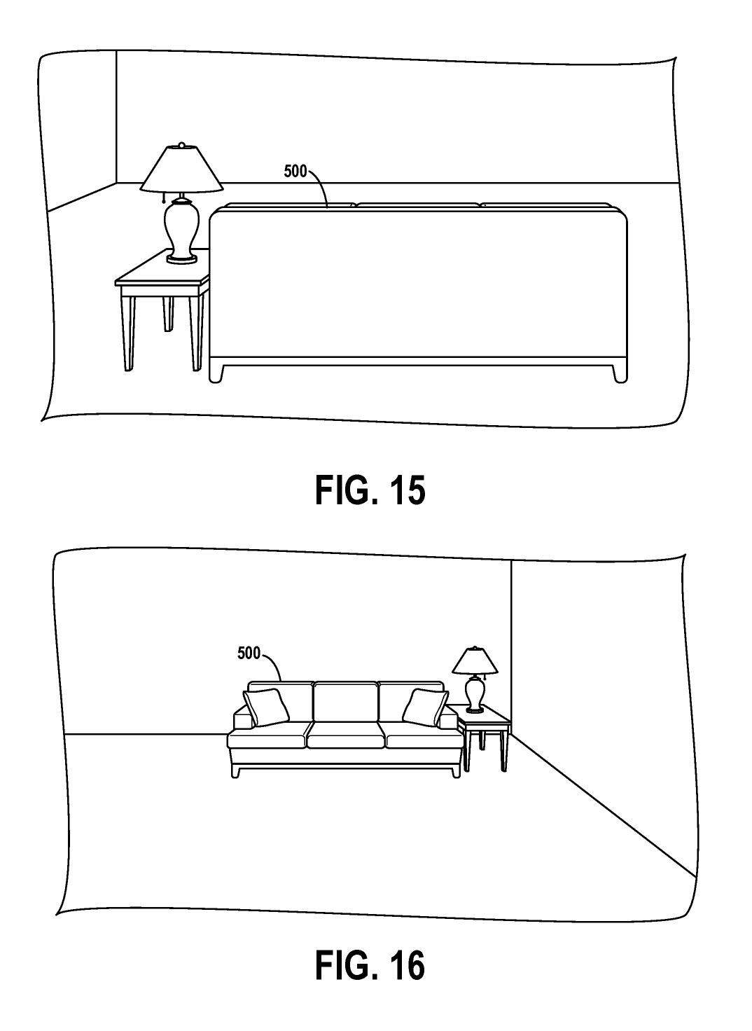

FIG. 14 is a conceptual illustration of example additional data of the object 500, according to an example implementation. In FIG. 14, a different perspective or pose of the object 500 is captured by the camera of the computing device 108 or the robotic device 200. The perspective is shown to be from an angle to provide a different viewpoint, for example.

FIG. 15 is a conceptual illustration of another example additional data of the object 500, according to an example implementation. In FIG. 15, another different perspective or pose of the object 500 is captured by the camera of the computing device 108 or the robotic device 200. The perspective is shown to be from a backside to provide a different viewpoint, for example.

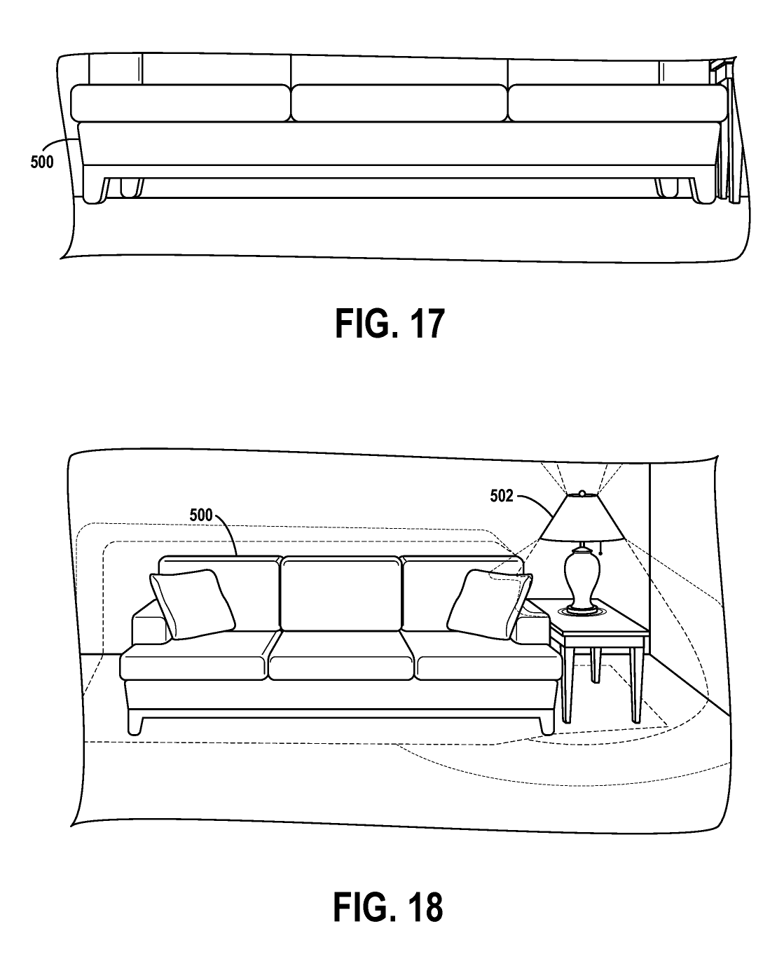

FIG. 16 is a conceptual illustration of another example additional data of the object 500, according to an example implementation. In FIG. 16, an image of the object 500 is captured from a farther distance away to provide yet another perspective viewpoint.

FIG. 17 is a conceptual illustration of another example additional data of the object 500, according to an example implementation. In FIG. 17, an image of the object 500 is captured from a closer distance to provide yet another perspective viewpoint.

FIG. 18 is a conceptual illustration of another example additional data of the object 500, according to an example implementation. In FIG. 18, an image of the object 500 is captured with different lighting in place. For example, in FIG. 18, a lamp 502 is on and shines lights onto and adjacent to the object 500.

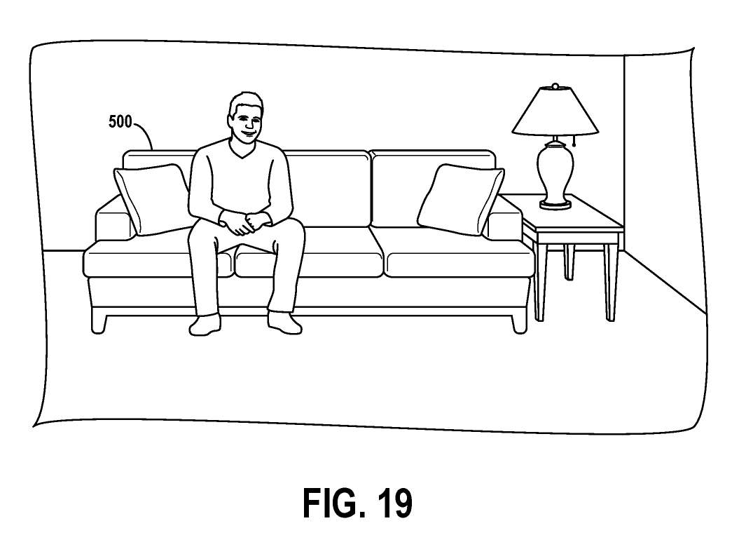

FIG. 19 is a conceptual illustration of another example additional data of the object 500, according to an example implementation. In FIG. 19, an image of the object 500 is captured with a person sitting on the object. In this image, information can be learned that the object 500 is used by people for sitting, for example.

In each of the images captured and shown in FIGS. 14-19, additional data of the object 500 is captured by obtaining an image of a different view of the object 500, or obtaining an image of the object 500 with different lighting in place. In addition, in each of the images captured and shown in FIGS. 14-19, additional data of a surrounding environment of the object 500 is captured when different viewpoints are used and other aspects of surrounding and adjacent environment of the couch are seen in the image. All of this information can then be used to generate the knowledge graph as described above. Within examples, the knowledge graph can then be used as a reference for object recognition, and when an image that includes perhaps a partial view of the object 500, for example as shown in FIG. 17 is captured, the computing device 108 and/or the robotic device 200 may reference the knowledge graph to identify that the object in the image is the couch even when a full view of the couch is not yet obtained.

Example knowledge graphs described herein may be useful for artificial intelligence functions of a computing or robotic device and/or for reference to recognize higher level spaces such as kitchens and living rooms based on observation of objects associated with those rooms. This enables increased precision and recall of object recognition. As an example, if the computing device 108 is not in the kitchen, then nodes of the knowledge graph referring to the kitchen are not referenced. Alternatively, when a kitchen appliance is recognized in an image, e.g., refrigerator, the computing device 108 can make a determination through inferences that the computing device 108 is located in a kitchen.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination, and all of such possibilities are intended to be within the scope of the disclosure.

The description of the different advantageous arrangements has been presented for purposes of illustration and description, and is not intended to be exhaustive or limited to the examples in the form disclosed. After reviewing and understanding the foregoing disclosure, many modifications and variations will be apparent to those of ordinary skill in the art. Further, different examples may provide different advantages as compared to other examples. The example or examples selected are chosen and described in order to best explain the principles, the practical application, and to enable others of ordinary skill in the art to understand the disclosure for various examples with various modifications as are suited to the particular use contemplated.

What is claimed is:

1. A computer-implemented method, comprising:
obtaining, using a camera of a computing device, a two-dimensional (2D) image of an object;
receiving, from a server, an identification of the object based on the 2D image of the object;
obtaining, using one or more sensors of the computing device, additional data of the object;
obtaining, using the one or more sensors of the computing device, additional data of a surrounding environment of the object; and
generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

2. The computer-implemented method of claim 1, wherein the one or more sensors of the computing device include the camera of the computing device, and wherein obtaining the additional data of the object comprises obtaining images of the object from additional points of view.

3. The computer-implemented method of claim 1, wherein the one or more sensors of the computing device include a depth camera of the computing device, and wherein obtaining the additional data of the object comprises obtaining depth images of the object.

4. The computer-implemented method of claim 1, wherein the one or more sensors of the computing device include a microphone of the computing device, and wherein obtaining the additional data of the object comprises obtaining, using the microphone, audio from the surrounding environment of the object.

5. The computer-implemented method of claim 1, wherein generating the knowledge graph comprises storing the additional data of the object with a label indicating the identification of the object.

6. The computer-implemented method of claim 1, wherein the computing device is a robotic device operable to move throughout an environment, and wherein obtaining, using the one or more sensors of the computing device, the additional data of the object comprises:
the robotic device moving around the object to collect data of the object using the one or more sensors on-board the robotic device.

7. The computer-implemented method of claim 1, wherein obtaining, using the one or more sensors of the computing device, the additional data of the object comprises obtaining the additional data at different times of day.

8. The computer-implemented method of claim 1, wherein obtaining the additional data of the object comprises obtaining audio including speech, and the method further comprises:
receiving, from another server, an output of speech recognition of the speech; and
assigning an entity identification to the knowledge graph using the output of the speech recognition of the speech, wherein the entity identification indicates an identification of a node of the knowledge graph.

9. The computer-implemented method of claim 1, wherein obtaining, using the camera of a computing device, the 2D image of the object comprises obtaining the 2D image at a particular time, and the method further comprises;
obtaining, from the computing device, a log of sensor data indicative of the surrounding environment of the object during a time period prior to the particular time; and
generating the knowledge graph to include the log of sensor data associated with the identification of the object.

10. The computer-implemented method of claim 1, wherein the additional data of the surrounding environment indicates a spatial layout between the at least one item represented by the additional data of the surrounding environment and the object, and wherein the method further comprises:
generating the knowledge graph to include information indicating the spatial layout between the at least one item represented by the additional data of the surrounding environment and the object.

11. The computer-implemented method of claim 1, further comprising:
receiving outputs of the one or more sensors of the computing device; and
accessing the knowledge graph to determine an identification of one or more objects represented by one or more of the outputs of the one or more sensors of the computing device.

12. The computer-implemented method of claim 1, further comprising:
determining a person associated with the object; and
generating the knowledge graph to include information indicating the person associated with the object to label the object as belonging to the person.

13. The computer-implemented method of claim 1, further comprising:
receiving, from another server, information indicating an activity related to a scene in the 2D image of the object; and
generating the knowledge graph to include the information indicating the activity associated with the identification of the object.

14. The computer-implemented method of claim 1, further comprising:
determining whether the object is stationary or movable; and
generating the knowledge graph to include information indicating whether the object is stationary or movable.

15. A computing device comprising:
a camera;
one or more sensors;
at least one processor;
memory; and
program instructions, stored in the memory, that upon execution by the at least one processor cause the computing device to perform operations comprising:
obtaining, using the camera, a two-dimensional (2D) image of an object;
receiving, from a server, an identification of the object based on the 2D image of the object;
obtaining, using the one or more sensors, additional data of the object;
obtaining, using the one or more sensors, additional data of a surrounding environment of the object; and
generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

16. The computing device of claim 15, wherein the one or more sensors of the computing device include a microphone of the computing device, and wherein obtaining the additional data of the object comprises:
obtaining, using the camera, images of the object from additional points of view;
obtaining, using the microphone, audio from an ambient environment of the object; and
obtaining, using the one or more sensors of the computing device, the additional data of the object comprises obtaining the additional data at different times of day.

17. The computing device of claim 15, wherein the program instructions further comprise instructions, stored in the memory, that upon execution by the at least one processor cause the computing device to perform operations comprising:
obtaining, using the camera of a computing device, the 2D image of the object at a particular time;
obtaining, from the computing device, a log of sensor data indicative of the surrounding environment of the object during a time period prior to the particular time; and
generating the knowledge graph to include the log of sensor data associated with the identification of the object.

18. A non-transitory computer-readable medium having stored therein instructions, that when executed by a computing device, cause the computing device to perform functions comprising:
obtaining, using a camera of the computing device, a two-dimensional (2D) image of an object;
receiving, from a server, an identification of the object based on the 2D image of the object;
obtaining, using one or more sensors of the computing device, additional data of the object;
obtaining, using the one or more sensors of the computing device, additional data of a surrounding environment of the object; and
generating a knowledge graph including (i) the additional data of the object associated with the identification of the object and (ii) the additional data of the surrounding environment of the object also associated with the identification of the object and organized in a hierarchical semantic manner to illustrate relationships between the object and at least one item represented by the additional data of the surrounding environment of the object.

19. The non-transitory computer-readable medium of claim 18, wherein the additional data of the surrounding environment indicates a spatial layout between the at least one item represented by the additional data of the surrounding environment and the object, and wherein the functions further comprise:
generating the knowledge graph to include information indicating the spatial layout between the at least one item represented by the additional data of the surrounding environment and the object.

20. The non-transitory computer-readable medium of claim 18, wherein the functions further comprise:
determining a person associated with the object; and
generating the knowledge graph to include information indicating the person associated with the object to label the object as belonging to the person.
